(19) United States
(12) Patent Application Publication
(10) Pub. No.: US 2016/0202457 A1
(43) Pub. Date: Jul. 14, 2016

(54) Wide-Angle Zoom Lens and Image Pickup Apparatus

(71) Applicant: Tamron Co., Ltd., Saitama-shi (JP)

(72) Inventor: Dayong Li, Saitama-shi (JP)

(21) Appl. No.: 14/990,207

(22) Filed: Jan. 7, 2016

(30) Foreign Application Priority Data
Jan. 8, 2015 (JP) 2015-002368

(51) Int. Cl. G02B 15/177; G02B 15/20; G02B 27/64

(52) U.S. Cl. CPC G02B 15/177; G02B 27/646; G02B 15/20

(57) ABSTRACT

A wide-angle zoom lens includes: a first lens group having a negative refractive power, a second lens group having positive refractive power, a third lens group having a negative refractive power and a fourth lens group having a positive refractive power in that order from an object side. The second lens group is configured with a front group, a stop and a rear group having a positive refractive power in that order from the object side. Magnification change is performed by changing distances among the lens groups.

### CROSS-REFERENCE TO RELATED APPLICATION

This application claims priority to Japanese Patent Application No. 2015-002368 filed Jan. 8, 2015, the disclosure of which is hereby incorporated in its entirety by reference.

### BACKGROUND OF THE INVENTION

1. Field of the Invention

The present invention relates to a wide-angle zoom lens and an image pickup apparatus equipped with the wide-angle zoom lens, and more particularly to a wide-angle zoom lens suitable for a lens-interchangeable type image pickup apparatus, such as a single-lens reflex camera, and an image pickup apparatus equipped with the wide-angle zoom lens.

2. Description of the Related Art

Conventionally, there has been known a four-group zoom lens composed of four lens groups having negative, positive, negative and positive refractive powers in that order from an object side, as a wide-angle zoom lens for a lens-interchangeable type image pickup apparatus such as a single-lens reflex camera (see, for example, Japanese Patent Laid-Open No. 2004-240038, No. 2006-039531, No. 2007-010913, No. 2010-243737 and No. 2008-249842).

Each of Japanese Patent Laid-Open No. 2004-240038, No. 2006-039531, No. 2007-010913, No. 2010-243737 and No. 2008-249842 discloses a wide-angle zoom lens with an image viewing angle of 100° or more at a wide angle end and a zoom ratio of about 2. Since a negative precedence type zoom lens can secure brightness and a backfocus, it is suitable as an interchangeable lens and the like for an image pickup apparatus requiring a backfocus, such as a single-lens reflex camera.

In these wide-angle zoom lenses, by causing a first lens group to have a large refractive power and arranging multiple aspheric surfaces in the first lens group, the size of the entire optical system is reduced, and various aberrations are excellently corrected.

In the wide-angle zoom lenses disclosed in Japanese Patent Laid-Open No. 2004-240038, No. 2006-039531 and No. 2007-010913, a lens having a strong negative refractive power is arranged on the most object side of the optical system, and at least one of the surfaces of the lens is an aspheric surface. By causing the lens arranged on the most object side to be an aspheric lens made of glass material with a high refractive index, occurrence of various aberrations is suppressed, and the diameter of a front lens is reduced. However, zoom ratios and image viewing angles at the wide angle end for the wide-angle zoom lenses described in Japanese Patent Laid-Open No. 2004-240038, No. 2006-039531 and No. 2007-010913 are “about 2.22; 104°”, “1.95 to 2.36; 105.8°” and “about 2.8; 101°”, respectively. Therefore, there is a demand for a wider angle while the zoom ratio of about 2 is secured.

On the other hand, the wide-angle zoom lenses disclosed in Patent Laid-Open No. 2010-243737 and No. 2008-249842 have a zoom ratio of about 2, and achieve an image viewing angle of about 110° at the wide angle end. When achieving a wider angle is attempted in the wide-angle zoom lenses disclosed in Patent Laid-Open No. 2010-243737 and No. 2008-249842, however, the distance between a first lens group and a second lens group is long, and it is difficult to reduce the diameters of lenses constituting the first lens group, and it is also difficult to shorten the overall optical length. Further, it is also difficult to reduce the diameters of the lenses constituting the first lens group and shorten the overall optical length while maintaining the zoom ratio of about 2 and the image viewing angle of about 110° at the wide angle end.

Therefore, an object of the present invention is to provide a wide-angle zoom lens which has almost the same zoom ratio as a conventional zoom ratio and in which a wider image viewing angle is achieved at a wide angle end, and a first lens group can be configured small so that the overall optical length is short.

### SUMMARY OF THE INVENTION

In order to achieve the above object, a wide-angle zoom lens according to the present invention includes: a first lens group having a negative refractive power, a second lens group having a positive refractive power, a third lens group having a negative refractive power and a fourth lens group having a positive refractive power in that order from an object, wherein the second lens group is configured with a front group, a stop and a rear group having a positive refractive power in that order from the object side; and magnification change is performed by changing distances among the lens groups.

### BRIEF DESCRIPTION OF THE DRAWINGS

FIG. 1 is a lens cross-sectional view of a wide-angle zoom lens of Example 1 of the present invention;

FIG. 2 shows a spherical aberration diagram, an astigmatism diagram and a distortion aberration diagram at the time of infinite-distance focusing in a wide angle end state of the wide-angle zoom lens of the Example 1;

FIG. 3 shows a spherical aberration diagram, an astigmatism diagram and a distortion aberration diagram at the time of infinite-distance focusing in an intermediate focal length state of the wide-angle zoom lens of Example 1;

FIG. 4 shows a spherical aberration diagram, an astigmatism diagram and a distortion aberration diagram at the time of infinite-distance focusing in a telephoto end state of the wide-angle zoom lens of Example 1;

FIG. 5 shows lateral aberration diagrams at the time of infinite-distance focusing in the wide angle end state, the intermediate focal length state and the telephoto end state of the wide-angle zoom lens of Example 1;

FIG. 6 is a lens cross-sectional view of a wide-angle zoom lens of Example 2 of the present invention;

FIG. 7 shows a spherical aberration diagram, an astigmatism diagram and a distortion aberration diagram at the time of infinite-distance focusing in a wide angle end state of the wide-angle zoom lens of Example 2;

FIG. 8 shows a spherical aberration diagram, an astigmatism diagram and a distortion aberration diagram at the time of infinite-distance focusing in an intermediate focal length state of the wide-angle zoom lens of Example 2;

FIG. 9 shows a spherical aberration diagram, an astigmatism diagram and a distortion aberration diagram at the time of infinite-distance focusing in a telephoto end state of the wide-angle zoom lens of Example 2;

FIG. 10 shows lateral aberration diagrams at the time of infinite-distance focusing in the wide angle end state, the intermediate focal length state and the telephoto end state of the wide-angle zoom lens of Example 2;

FIG. 11 is a lens cross-sectional view of a wide-angle zoom lens of Example 3 of the present invention;

FIG. 12 shows a spherical aberration diagram, an astigmatism diagram and a distortion aberration diagram at the time of infinite-distance focusing in a wide angle end state of the wide-angle zoom lens of Example 3;

FIG. 13 shows a spherical aberration diagram, an astigmatism diagram and a distortion aberration diagram at the time of infinite-distance focusing in an intermediate focal length state of the wide-angle zoom lens of Example 3;

FIG. 14 shows a spherical aberration diagram, an astigmatism diagram and a distortion aberration diagram at the time of infinite-distance focusing in a telephoto end state of the wide-angle zoom lens of Example 3;

FIG. 15 shows lateral aberration diagrams at the time of infinite-distance focusing in the wide angle end state, the intermediate focal length state and the telephoto end state of the wide-angle zoom lens of Example 3;

FIG. 16 is a lens cross-sectional view of a wide-angle zoom lens of Example 4 of the present invention;

FIG. 17 shows a spherical aberration diagram, an astigmatism diagram and a distortion aberration diagram at the time of infinite-distance focusing in a wide angle end state of the wide-angle zoom lens of Example 4;

FIG. 18 shows a spherical aberration diagram, an astigmatism diagram and a distortion aberration diagram at the time of infinite-distance focusing in an intermediate focal length state of the wide-angle zoom lens of Example 4;

FIG. 19 shows a spherical aberration diagram, an astigmatism diagram and a distortion aberration diagram at the time of infinite-distance focusing in a telephoto end state of the wide-angle zoom lens of Example 4; and

FIG. 20 shows lateral aberration diagrams at the time of infinite-distance focusing in the wide angle end state, the intermediate focal length state and the telephoto end state of the wide-angle zoom lens of Example 4.

### DETAILED DESCRIPTION OF THE PREFERRED EMBODIMENTS

Embodiments of a wide-angle zoom lens and an image pickup apparatus according to one embodiment of the present invention will be described below.

### 1. Wide-Angle Zoom Lens

### 1-1. Optical Construction of Wide-Angle Zoom Lens

A wide-angle zoom lens according to one embodiment of the present invention is characterized in including a first lens group having a negative refractive power, a second lens group having a positive refractive power, a third lens group having a negative refractive power and a fourth lens group having a positive refractive power in that order from an object; the second lens group being configured with a front group, a stop and a rear group having a positive refractive power in that order from an object side; and magnification change being performed by changing distances among the lenses.

The zoom lens of the present invention is a wide-angle zoom lens in a four-group construction in which negative-positive-negative-positive power arrangement is adopted. A degree of freedom of moving each lens group at the time of magnification change is high, and a high zoom ratio is easily achieved. At the same time, it becomes easy to suppress variation in aberration in the entire zoom area, and, therefore, a zoom lens with high image formation performance can be obtained. Furthermore, by adopting a negative lead type wide-angle zoom lens in which the refractive power of a first lens group is negative, a backfocus can be secured. Thus, the zoom lens is suitable as an imaging lens requiring a predetermined backfocus such as an interchangeable lens for a single lens reflex camera. Configuration of each lens group will be described below.

### (1) First Lens Group

A specific lens construction of the first lens group is not especially limited as far as the first lens group has a negative refractive power as described above. It is favorable, however, that at least any one of surfaces of a lens arranged on the most object side is an aspheric surface, and it is more favorable that both surfaces of the lens are aspheric surfaces. By causing any one of the surfaces of the lens arranged on the most object side to be an aspheric surface, it is possible to strengthen the refractive power of a so-called front lens. Thereby, it is possible to achieve reduction in size of the front lens and suppress coma aberration and distortion aberration. Especially, in the optical zooming lens according to one embodiment of the present invention, it is preferable to cause the image plane side surface of the lens arranged on the most object side to be aspheric. Further, in this case, it is preferable that the lens is made of glass material with a high refractive index and is an aspheric lens the lens surface of which is machined to be aspheric.

Further, it is preferable to configure the first lens group with a front group having a negative refractive power and a rear group having a negative refractive power, and perform focusing from an object at infinity to a short-distance object by moving the rear group to the object side. In a negative precedence type wide-angle zoom lens like the wide-angle zoom lens according to one embodiment of the present invention, external diameters of lenses constituting the first lens group are the largest in the entire optical system. In the case of configuring the first lens group with the front group and the rear group and moving the rear group to the object side at the time of focusing, it is necessary to secure an air space between the front group and the rear group which is equal to or larger than an amount of focus movement. In this case, in the case of obtaining a wide angle of 110° or more also, it becomes easy to configure the rear group with lenses having smaller external diameters in comparison with the front group. Therefore, it is possible to achieve reduction in weight and size of a focus group. At the same time, it is possible to achieve reduction in size of lens groups after the rear group of the first lens group, and, therefore, it is possible to achieve reduction in size and weight of the entire wide-angle zoom lens. In the case of causing the rear group of the first lens group to be the focus group, it is more preferable that an expression (3) to be described later is satisfied.

### (2) Second Lens Group

A specific lens construction of the second lens group is not especially limited as far as the second lens group has a positive refractive power. In the present invention, an aperture stop is arranged in the second lens group, and the second lens group is configured with a front group having a positive or negative refractive power and a rear group having a positive refractive power in that order from the object side, with the aperture stop sandwiched by the front and rear groups. For example, by adopting a four-group construction for the negative precedence type wide-angle zoom lens, which is called a negative lead type, and configuring the second lens group having a positive refractive power as described above, it is possible to reduce external diameters of lenses constituting the second lens group and achieve reduction in size of the entire wide-angle zoom lens. Further, by arranging the aperture stop in the second lens group, it is possible, for example, to shorten the distance between the first lens group and the second lens group on an optical axis at a telephoto end, and it is possible to achieve reduction in size in the direction of the overall optical length at the telephoto end. That is, when each lens group is moved so that the distance between the first lens group and the second lens group is decreased at the telephoto end, the distance between both lens groups can be decreased more in comparison with the case where the aperture stop is arranged between the first lens group and the second lens group since the aperture stop does not exist between the first lens group and the second lens group. Further, by configuring the second lens group with the front group and the rear group having a positive refractive power, and arranging the aperture stop between the front and rear groups, excellent positional balance between the position of an entrance pupil and the position of an exit pupil is obtained. Thereby, even if attempting a wide angle of 110° or more, it is possible to reduce the external diameters of lenses constituting each lens group, and it is possible to prevent the effect diameter of the front lens or the rear lens from being too large.

Further, it is favorable that each of the front and rear groups is configured with at least one negative lens and one positive lens. By adopting this construction, it is possible to distribute power appropriately in achieving a wider angle, and achieve reduction in size of the entire wide-angle zoom lens.

### (3) Third Lens Group

Though a specific lens construction of the third lens group is not especially limited as far as the third lens group has a negative refractive power, it is preferable to use the third lens group as an image stabilization group in the wide-angle zoom lens according to one embodiment of the present invention. That is, it is preferable to move the third lens group in a direction vertical to the optical axis to move an image at the time of image stabilization. By using the third lens group as an image stabilization group, it is possible to, when image blurring occurs due to vibration such as hand shake at the time of imaging, move an image to correct the image blurring by moving the third lens group in the direction vertical to the optical axis. In the present invention, when the direction vertical to the optical axis is mentioned, it is assumed that a case where the movement direction of the third lens group includes a component vertical to the optical axis is also included in addition to a case where the movement direction of the third lens group is vertical to the optical axis.

It is preferable that the third lens group is configured, including a lens having a negative refractive power and a lens having a positive refractive power. Especially, it is preferable that the third lens group is configured with a cemented lens composed of a lens having a negative refractive power and a lens having a positive refractive power. By adopting this construction, it is possible to excellently correct color aberration at the time of image stabilization and suppress occurrence of decentering coma aberration. Further, by configuring the third lens group with a cemented lens, it is possible to facilitate assembly of an image stabilization group, and it is possible to suppress occurrence of manufacturing errors. At the same time, by configuring the third lens group with a cemented lens, it is possible to achieve reduction in weight of the third lens group and achieve reduction in size and weight of an actuator or the like for driving the third lens group at the time of image stabilization. Therefore, it is possible to prevent the lens barrel diameter and the like of the wide-angle zoom lens from increasing even when using the third lens group as an image stabilization group.

### (4) Fourth Lens Group

A specific lens construction of the fourth lens group is not especially limited as far as the fourth lens group has a positive refractive power. In the wide-angle zoom lens according to one embodiment of the present invention, other lens groups such as a fixed group which is fixed at the time of magnification change may be arranged on the image side of the fourth lens group. From a viewpoint of reducing the size of the wide-angle zoom lens in the direction of the overall optical length, however, it is preferable to cause the fourth lens group to be the last group.

### 1-2. Operation of Each Lens Group at the Time of Magnification Change

Next, an operation of each lens group at the time of magnification change will be described. In the wide-angle zoom lens according to one embodiment of the present invention, magnification change is performed by changing distances among the lens groups. For example, at the time of magnification change from the wide angle end to the telephoto end, it is preferable to change the distances among the lens groups so that the distance between the first lens group and the second lens group is decreased, the distance between the second lens group and the third lens group is increased, and the distance between the third lens group and the fourth lens group is decreased.

### 1-3. Expression

Next, each expression will be described.

### 1-3-1. Expression (1)

It is preferable that the wide-angle zoom lens according to one embodiment of the present invention satisfies an expression (1) below.

0.4<F2/f2b<2 (1)

wherein

F2 represents focal length of the second lens group; and

f2b represents focal length of the rear group of the second lens group.

The expression (1) is an expression for a ratio of the focal length of the second lens group to the focal length of the rear group of the second lens group. If the expression (1) is satisfied, the distance between a principal point on the image side of the first lens group at the wide angle end and a principal point on the object side of the second lens group is short, it is possible to, when an image viewing angle of 110° or more is secured at the wide angle end, achieve reduction in size of the wide-angle zoom lens in the direction of the overall optical length.

If the numerical value of the expression (1) is equal to or below a lower limit, the refractive power of the front group of the second lens group is too strong, or the refractive power of the rear group of the second lens group is too weak. Therefore, the distance between the principal point on the image side of the first lens group and the principal point on the object side of the second lens group is too short, and, though it is advantageous in reduction in the size of the wide-angle zoom lens, it becomes difficult to secure the image viewing angle of 110° or more at the wide angle end. In comparison, if the numerical value of the expression (1) is equal to or above an upper limit, the refractive power of the front group of the second lens group is too weak, or the refractive power of the rear group of the second lens group is too strong. Therefore, though it becomes easy to secure the image viewing angle of 110° or more at the wide angle end, the distance between the principal point on the image side of the first lens group at the wide angle end and the principal point on the object side of the second lens group becomes too long, and it becomes difficult to achieve reduction in size of the wide-angle zoom lens.

In order to obtain these advantages, it is preferable that the wide-angle zoom lens satisfies an expression (1a) below, and it is more preferable that the wide-angle zoom lens satisfies an expression (1b).

0.5<F2/f2b<1.6 (1a)

0.6<F2/f2b<1.3 (1b)

### 1-3-2. Expression (2)

It is preferable that the optical system according to one embodiment of the present invention satisfies an expression (2) below.

0.1<|F1/F234w|<0.7 (2)

wherein

F234w represents focal length of all lens groups arranged on an image plane side of the first lens group at the wide angle end; and

F1 represents focal length of the first lens group.

The expression (2) is an expression for a ratio of the focal length of all the lens groups arranged on the image plane side of the first lens group at the wide angle end to the focal length of the first lens group. By satisfying the expression (2), it becomes more easy to secure the image viewing angle of 110° or more at the wide angle end, and it is possible to further achieve reduction in size of the wide-angle zoom lens. Further, it becomes easy to secure a backfocus required for a single lens reflex camera and the like.

In comparison, if the numerical value of the expression (2) is equal to or below a lower limit, the refractive power of the first lens group becomes too strong, and it becomes difficult to correct peripheral coma aberration and chromatic aberration of magnification though it becomes easy to achieve a wider angle and secure a backfocus. Therefore, in order to obtain excellent image informing performance in the entire zoom area, from the wide angle end to the telephoto end, the number of lenses required for aberration correction increases, and it becomes difficult to achieve reduction in size of the wide-angle zoom lens. On the other hand, if the numerical value of the expression (2) is equal to or above an upper limit, the refractive power of the first lens group becomes too weak, and it becomes difficult to achieve reduction in size of the wide-angle zoom lens as well as obtain a wide angle of 110° or more while securing almost the same zoom ratio as a conventional wide-angle zoom lens.

In order to obtain these advantages, it is preferable that the wide-angle zoom lens satisfies an expression (2a) below, and it is more preferable that the wide-angle zoom lens satisfies an expression (2b).

0.2<|F1/F234w|<0.6 (2a)

0.3<|F1/F234w|<0.5 (2b)

### 1-3-3. Expression (3)

In the wide-angle zoom lens according to one embodiment of the present invention, it is preferable that an expression (3) below is satisfied in the case where the first lens group is configured with the front group having a negative refractive power and the rear group having a negative refractive power in that order from an object, and focusing from an object at infinity to a short-distance object is performed by moving the rear group to the object side as described above.

1<f2b/Fw<6 (3)

wherein

FW represents focal length of an entire wide-angle zoom lens system at the wide angle end; and

f2b represents focal length of the rear group of the second lens group.

The expression (3) is an expression for a ratio of the focal length of the rear group of the second lens group to the focal length of the entire wide-angle zoom lens system at the wide angle end. If the rear group of the first lens group is caused to be a focus group, and the expression (3) is satisfied, balance between the refractive powers of the front and rear groups of the second lens group is within an appropriate range, and the distance between the principal point of the first lens group at the wide angle end and the principal point on the object side of the second lens group can be decreased. Therefore, even when the image viewing angle of 110° or more is secured at the wide angle end, it is possible to further achieve reduction in size of the wide-angle zoom lens in the direction of the overall optical length.

In comparison, if the numerical value of the expression (3) is equal to or below a lower limit, the refractive power of the rear group of the second lens group becomes too weak, that is, the refractive power of the front group of the second lens group becomes too strong, and an amount of focus movement decreases. Therefore, though it is advantageous in reduction of the size of the wide-angle zoom lens in the direction of the overall optical length, it becomes difficult to achieve an image viewing angle exceeding 110° at the wide angle end. Further, in this case, since the amount of movement of the focus group is small, it is necessary to perform position control of the focus group extremely accurately. Furthermore, it becomes difficult to correct various aberrations such as color aberration and coma aberration. On the other hand, if the numerical value of the expression (3) is equal to or above an upper limit, the refractive power of the rear group of the second lens group becomes too strong, that is, the refractive power of the front group of the second lens group becomes too weak. Therefore, though it becomes easy to achieve the image viewing angle exceeding 110° at the wide angle end, the amount of focus movement increases, and it becomes difficult to reduce the overall optical length.

### 2. Image Pickup Apparatus

Next, an image pickup apparatus according to one embodiment of the present invention will be described. The image pickup apparatus according to one embodiment of the present invention is characterized in including the wide-angle zoom lens described above and an image sensor receiving an image formed by the wide-angle zoom lens. Note that the image sensor and the like are not especially limited, and a solid-state image sensor and the like, such as a CCD sensor and a CMOS sensor, can be used. The image pickup apparatus according to one embodiment of the present invention is suitable as an using the solid-state image sensor, such as a digital camera and a video camera. Further, of course, the image pickup apparatus may be a lens-fixed type image pickup apparatus in which a lens is fixed to a casing or may be a lens-interchangeable type image pickup apparatus such as a single lens reflex camera and a mirrorless single lens camera. However, the backfocus of the wide-angle zoom lens according to one embodiment of the present invention is relatively long. Therefore, it is preferable that the according to one embodiment of the present invention is an image pickup apparatus with a relatively long backfocus, such as a single lens reflex camera.

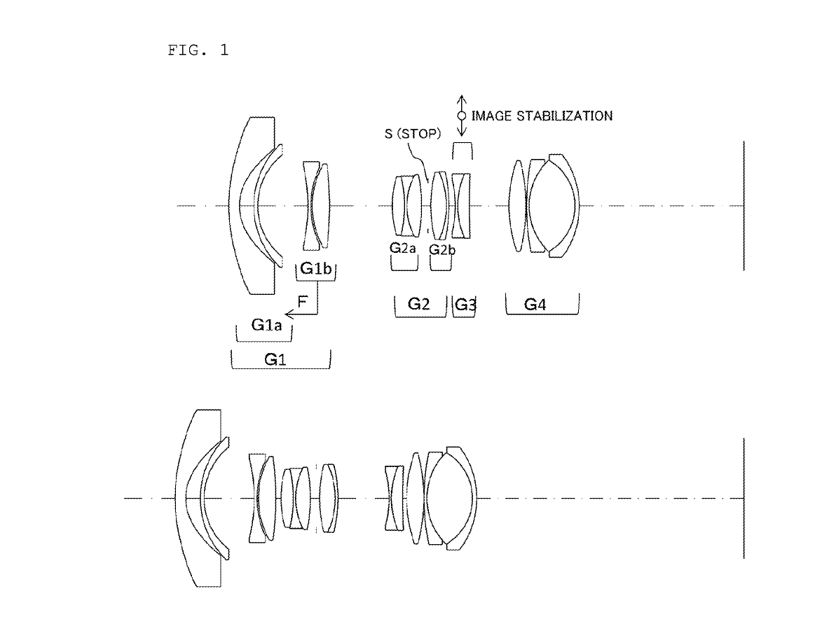

Next, the present invention will be specifically described by showing examples. Note that the present invention is not limited to the examples below. A zoom lens of each of the examples shown below is a wide-angle zoom lens used for image pickup apparatuses (optical apparatuses) such as a digital camera, a video camera and a silver-salt film camera, especially image pickup apparatuses with a relatively long backfocus such as a single lens reflex camera. In lens cross-sectional views (FIGS. 1, 6, 11 and 16), the left side of the drawings indicates the object side, and the right side indicates the image side.

### Example 1

### (1) Configuration of Wide-Angle Zoom Lens

FIG. 1 is a lens cross-sectional view showing a construction of a wide-angle zoom lens according to a Example 1 of the present invention. The wide-angle zoom lens is configured with a first lens group G1 having a negative refractive power, a second lens group G2 having a positive refractive power, a third lens group G3 having a negative refractive power and a fourth lens group G4 having a positive refractive power in that order from the object side.

The first lens group G1 is configured with a front group G1a having a negative refractive power and a rear group G1b having a negative refractive power in that order from the object side. A lens arranged on the most object side in the first lens group G1 is a meniscus lens being concave on the image plane side and having a negative refractive power, and both surfaces of the lens are machined to be aspheric. Further, the rear group G1b is used as a focus group. Focusing from an object at infinity to a short-distance object is performed by moving the rear group G1b to the object side. Specific lens constructions of the front group G1a and the rear group G1b are as shown in FIG. 1.

The second lens group G2 is configured with a front group G2a having a weak positive refractive power and a rear group G2b having a positive refractive power in that order from the object side. An aperture stop S is arranged between the front group G2a and the rear group G2b. The front group G2a, the rear group G2b and the aperture stop S move in an integrated state at the time of magnification change. Specific lens constructions of the front group G2a and the rear group G2b are as shown in FIG. 1.

The third lens group G3 is configured with a cemented lens composed of a negative lens and a positive lens in that order from the object side. The third lens group G3 moves in the direction vertical to the optical axis at the time of image stabilization and used as an image stabilization group for moving an image.

The fourth lens group G4 has a positive refractive power, and its specific lens construction is as shown in FIG. 1.

At the time of zooming (magnification change) from the wide angle end to the telephoto end, each of the lens groups moves to the object side so that the distance between the first lens group G1 and the second lens group G2 is decreased, the distance between the second lens group G2 and the third lens group G3 is increased, and the distance between the third lens group G3 and the fourth lens group G4 is decreased.

### (2) Typical Numerical Values

Next, typical numerical values in which specific numerical values of the wide-angle zoom lens are applied will be described. Table 1 shows lens data of the wide-angle zoom lens. In Table 1, “Surface No.” indicates a position number (a surface number) of a lens surface in order from the object side; “r” indicates a radius of curvature of the lens surface; “d” indicates a distance of the lens surface on the optical axis; “Nd” indicates a refractive index relative to a d-line (wavelength λ=587.6 nm); and “Vd” indicates an abbe number relative to the d-line. Further, when a lens surface is aspheric, an asterisk (*) is added next to the surface number, and a paraxial radius of curvature is shown in the column of the radius of curvature r.

Further Table 2 (2-1) shows, an aspheric coefficient and conic constant of each of the aspheric surfaces shown in Table 1 in the case where its shape is indicated by the following expression.

z=ch²/[1+{1−(1+k)c²h²}^{1/2}]+A4h⁴+A6h⁶+A8h⁸+A10h¹⁰

(wherein a curvature (1/r) is indicated by c; a height from the optical axis is indicated by h; a conic coefficient is indicated by k; and aspheric coefficients of respective orders are indicated by A4, A6, A8, A10 . . . . )

In Table 2 (2-2), “f” indicates the wide angle end, an intermediate focal length, and a focal length of the wide-angle zoom lens at the telephoto end. Further, “D(i)” (i=4, 6, 16, 19) indicates variable intervals of the lens surfaces shown in Table 1 on the optical axis, which are distances at the time of infinite-distance focusing at the wide angle end, the intermediate focal length and the telephoto end. In the tables, the unit of length is “mm”, and the unit of image viewing angle is “°”. Further, Table 9 shows numerical values of the expressions (1) to (3). As for the matters related to the tables, the same goes for tables shown in Examples 2 to 4, and, therefore, description of those in the tables will be omitted below.

Further, F values (FNo.) and image viewing angles (2ω) at the wide angle end, the intermediate focal length and the telephoto end of the wide-angle zoom lens will be shown below.

FNO.=3.6 to 4.1 to 4.6

2ω=111.70 to 86.59 to 62.07

TABLE 1

| SURFACE NO. | r | d | Nd | vd | |
|---|---|---|---|---|---|
| 1* | 40.045 | 2.500 | 1.6935 | 53.20 | |
| 2* | 11.000 | 3.469 | | | |
| 3 | 20.000 | 0.900 | 1.7292 | 54.67 | |
| 4 | 15.237 | D(4) | | | |
| 5 | −40.349 | 0.700 | 1.8348 | 42.72 | |
| 6 | 21.092 | 0.308 | | | |
| 7 | 19.747 | 4.093 | 1.6727 | 32.17 | |
| 8 | −73.731 | D(8) | | | |
| 9 | 23.217 | 2.893 | 1.4875 | 70.44 | |
| 10 | −32.655 | 0.600 | 1.8810 | 40.14 | |
| 11 | 15.614 | 3.440 | 1.6477 | 33.84 | |
| 12 | −37.246 | 1.400 | | | |
| 13 | INF | 0.800 | | | (APERTURE |
| | | | | | STOP) |
| 14 | 31.546 | 3.693 | 1.5955 | 39.22 | |
| 15 | −19.098 | 0.600 | 1.9229 | 20.88 | |
| 16 | −35.417 | D(16) | | | |
| 17* | −26.495 | 0.600 | 1.7680 | 49.24 | |
| 18 | 18.847 | 2.707 | 1.8467 | 23.78 | |
| 19 | 189.684 | D(19) | | | |
| 20 | 32.000 | 3.985 | 1.4970 | 81.61 | |
| 21 | −43.000 | 0.150 | | | |
| 22 | 57.310 | 0.600 | 1.8810 | 40.14 | |
| 23 | 14.750 | 10.807 | 1.4970 | 81.61 | |
| 24 | −12.387 | 1.000 | 1.6889 | 31.16 | |
| 25* | −19.855 | D(25) | | | |

TABLE 2
(2-1)

| SURFACE NO. | k | A4 | A6 | A8 | A10 | A12 |
|---|---|---|---|---|---|---|
| 1 | 0.1134 | 5.1831E−06 | −1.1118E−07 | 4.0401E−10 | −6.0810E−13 | 3.6453E−16 |
| 2 | −1.0385 | 2.7974E−05 | −8.9328E−08 | −1.8028E−09 | 1.1384E−11 | −1.1493E−14 |
| 17 | −0.3293 | 4.4631E−06 | 5.4568E−08 | −8.3698E−10 | 4.6814E−12 | 0.0000E+00 |
| 25 | 0.0795 | 8.2695E−06 | −1.6739E−08 | −1.1282E−11 | −1.1075E−12 | 0.0000E+00 |

(2-2)

| | WIDE | | TELEPHOTO |
|---|---|---|---|
| | ANGLE END | INTERMEDIATE | END |
| f | 10.303 | 15.199 | 23.483 |
| D(4) | 11.848 | 11.848 | 11.848 |
| D(8) | 14.751 | 6.792 | 1.200 |
| D(16) | 1.490 | 6.772 | 12.046 |
| D(19) | 9.366 | 5.208 | 0.900 |
| D(25) | 38.824 | 46.843 | 62.989 |

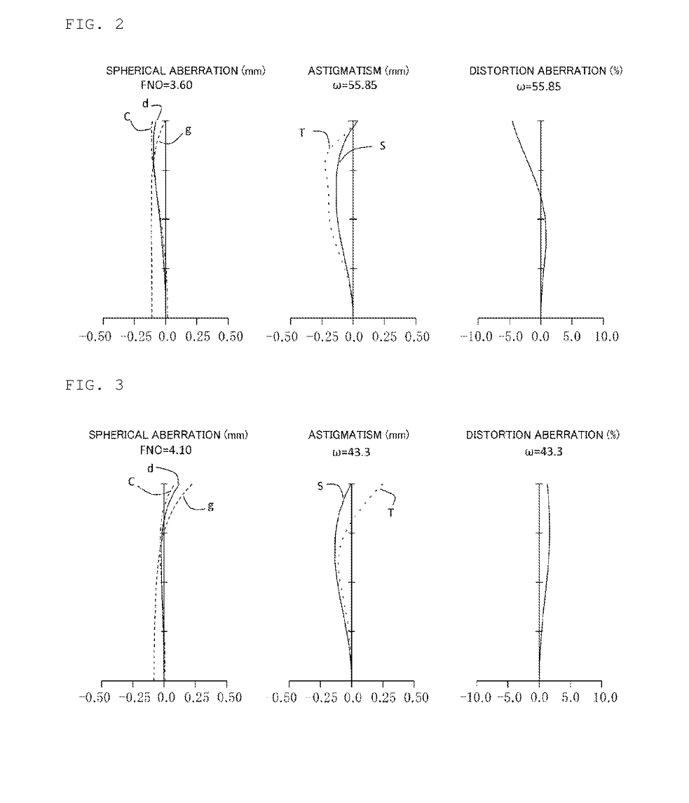

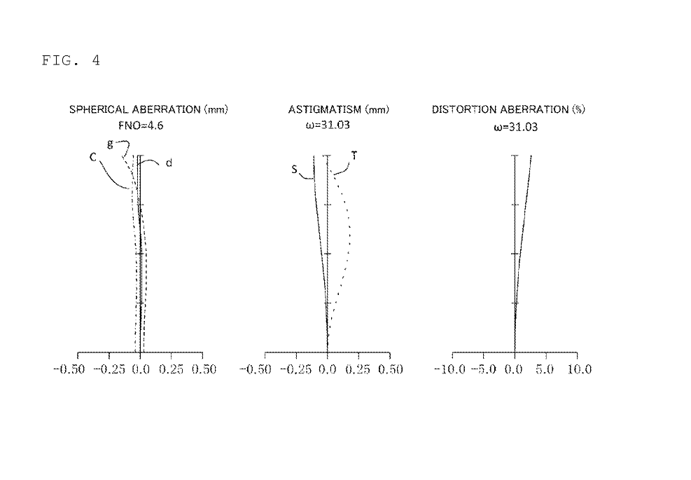

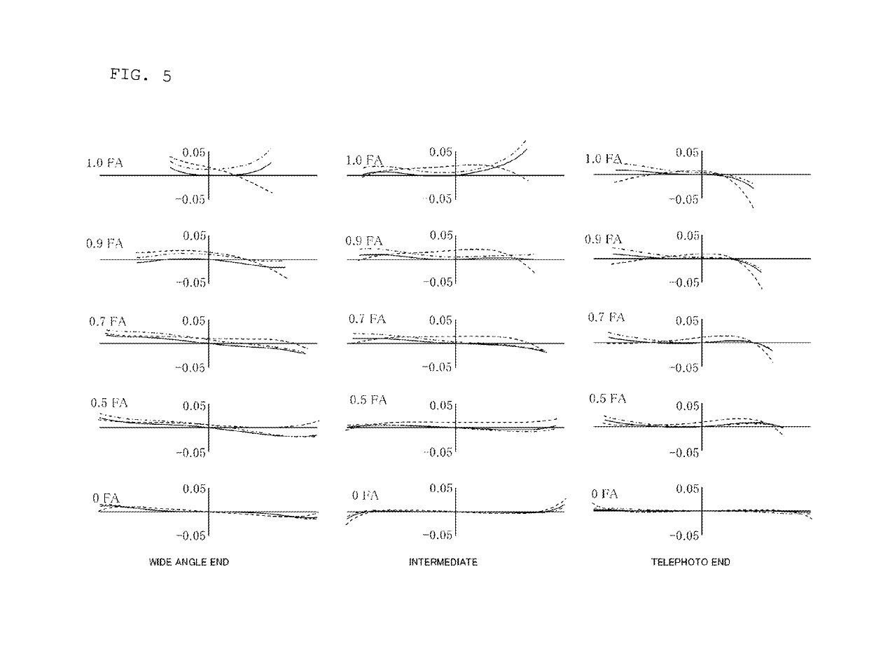

Further, FIGS. 2, 3 and 4 show longitudinal aberration diagrams of the wide-angle zoom lens at the time of infinite-distance focusing at the wide angle end, the intermediate focal length and the telephoto end, respectively. The longitudinal aberration diagrams show spherical aberration, astigmatism and distortion aberration, respectively, in that order from the left side of the drawing. In the spherical aberration diagram, the vertical axis indicates the F value; a solid line d indicates a characteristic of the d-line (λ=587.6 nm), a wavy line g indicates a characteristic of a g-line (λ=435.8 nm), and a long dashed short dashed line C indicates a characteristic of a c-line (λ=656.3 nm). In the astigmatism diagram, the vertical line indicates the image viewing angle, the solid line S shows a characteristic of a sagittal image plane on the d-line, and a broken line T shows a characteristic of a meridional image plane on the d-line. In the distortion aberration diagram, the vertical line indicates the image viewing angle, showing a characteristic on the d-line.

Furthermore, FIG. 5 shows lateral aberration diagrams of the wide-angle zoom lens at the wide angle end, the intermediate focal length and the telephoto end. In each of the lateral aberration diagrams at the wide angle end, the intermediate focal length, lateral aberration at 100%, 90%, 70% and 50% of a maximum image height are shown in that order from the top. Further, in each of the lateral aberration diagrams, the horizontal axis indicates a distance from a principal light beam on a pupil plane, the solid line indicates a characteristic of the d-line, the short dashed line indicates a characteristic of the g-line, and the long dashed line indicates a characteristic of the c-line.

As for the matters related to these diagrams, the same goes for diagrams shown in Examples 2 to 9, and, therefore, description of those in the diagrams will be omitted below.

### Example 2

### (1) Configuration of Wide-Angle Zoom Lens

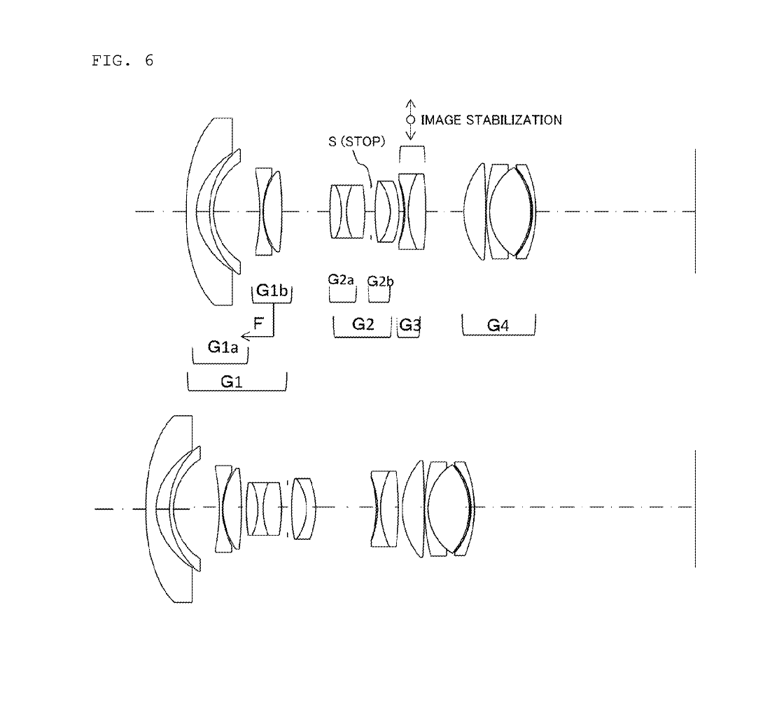

FIG. 6 is a lens cross-sectional view showing a construction of an optical system of a wide-angle zoom lens of Example 2. The wide-angle zoom lens of Example 2 is configured with a first lens group G1 having a negative refractive power, a second lens group G2 having a positive refractive power, a third lens group G3 having a negative refractive power and a fourth lens group G4 having a positive refractive power in that order from the object side.

The first lens group G1 is configured with a front group G1a having a negative refractive power and a rear group G1b having a negative refractive power in that order from the object side. A lens arranged on the most object side in the first lens group G1 is a meniscus lens being concave on the image plane side and having a negative refractive power, and both surfaces of the lens are machined to be aspheric. Further, the rear group G1b is used as a focus group. Focusing from an object at infinity to a short-distance object is performed by moving the rear group G1b to the object side. Specific lens constructions of the front group G1a and the rear group G1b are as shown in FIG. 6.

The second lens group G2 is configured with a front group G2a having a weak positive refractive power and a rear group G2b having a positive refractive power in that order from the object side. An aperture stop S is arranged between the front group G2a and the rear group G2b. The front group G2a, the rear group G2b and the aperture stop S move in an integrated state at the time of magnification change. Specific lens constructions of the front group G2a and the rear group G2b are as shown in FIG. 6.

The third lens group G3 is configured with a cemented lens composed of a negative lens and a positive lens in that order from the object side. The third lens group G3 moves in the direction vertical to the optical axis at the time of image stabilization and used as an image stabilization group for moving an image.

The fourth lens group G4 has a positive refractive power, and its specific lens construction is as shown in FIG. 6.

At the time of zooming (magnification change) from the wide angle end to the telephoto end, each of the lens groups moves to the object side so that the distance between the first lens group G1 and the second lens group G2 is decreased, the distance between the second lens group G2 and the third lens group G3 is increased, and the distance between the third lens group G3 and the fourth lens group G4 is decreased.

### (2) Typical Numerical Values

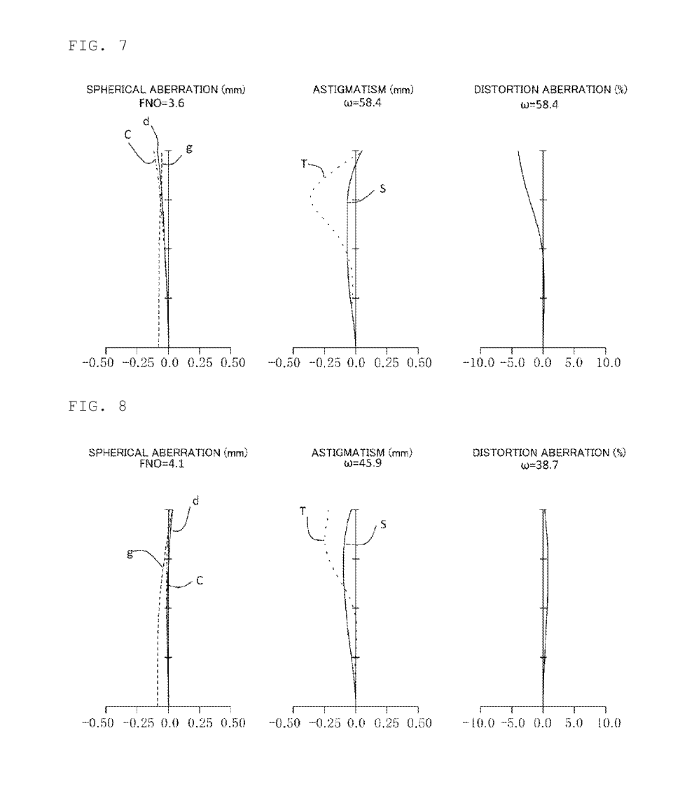

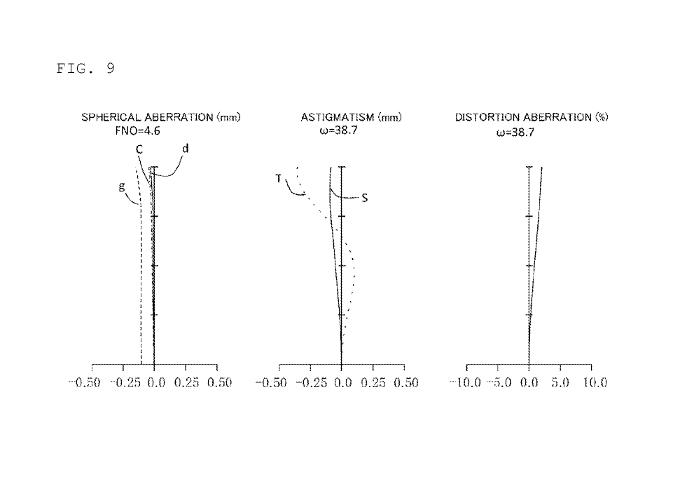

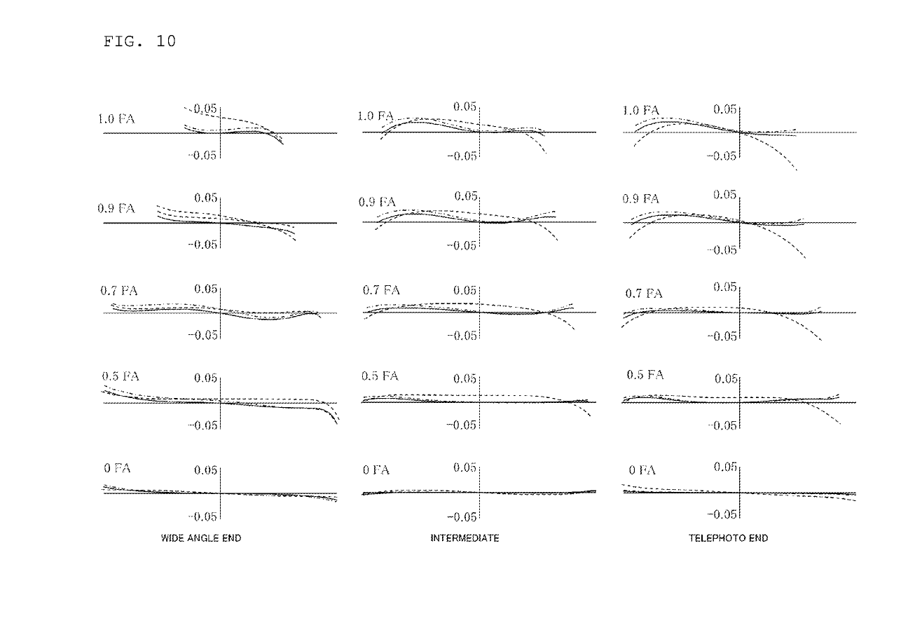

Next, typical numerical values in which specific numerical values of the wide-angle zoom lens are applied will be described. Table 3 shows lens data of the wide-angle zoom lens. Table 4 (4-1) shows an aspheric coefficient and conic constant of each of aspheric surfaces shown in Table 3, and Table 4 (4-2) shows a focal length (f) at each of the wide angle end, the intermediate focal length and the telephoto end of the wide-angle zoom lens, and variable intervals of lens surfaces shown in Table 3 on the optical axis. Further, F values (FNo.) and image viewing angles (2ω) at the wide angle end, the intermediate focal length and the telephoto end of the wide-angle zoom lens will be shown below. Further, numerical values of the expressions (1) to (3) are shown in Table 9. Furthermore, FIGS. 7, 8 and 9 show longitudinal aberration diagrams of the wide-angle zoom lens at the time of infinite-distance focusing at the telephoto end, the intermediate focal length and the wide angle end, respectively, and FIG. 10 shows lateral aberration diagrams at the wide angle end, the intermediate focal length and the telephoto end of the wide-angle zoom lens.

FNO.=3.6 to 4.1 to 4.6

2ω=116.75 to 91.87 to 77.35

TABLE 3

| SURFACE NO. | r | d | Nd | vd | |
|---|---|---|---|---|---|
| 1* | 92.402 | 2.500 | 1.6188 | 63.85 | |
| 2* | 13.692 | 3.229 | | | |
| 3 | 19.838 | 1.000 | 1.8810 | 40.14 | |
| 4 | 14.439 | D(4) | | | |
| 5 | −48.691 | 0.800 | 1.8810 | 40.14 | |
| 6 | 18.903 | 0.110 | | | |
| 7 | 16.534 | 4.474 | 1.6200 | 36.30 | |
| 8 | −88.119 | D(8) | | | |
| 9 | 51.334 | 2.807 | 1.5673 | 42.84 | |
| 10 | −14.69 | 1.237 | 1.8810 | 40.14 | |
| 11 | 16.68 | 4.443 | 1.6477 | 33.84 | |
| 12 | −39.594 | 1.500 | | | |
| 13 | INF | 1.000 | | | (APERTURE |
| | | | | | STOP) |
| 14 | 44.223 | 3.586 | 1.6034 | 38.01 | |
| 15 | −12.216 | 2.242 | 1.9229 | 20.88 | |
| 16 | −19.114 | D(16) | | | |
| 17* | −22.943 | 0.300 | 1.5146 | 49.96 | |
| 18 | −20.322 | 0.800 | 1.8042 | 46.50 | |
| 19 | 20.838 | 4.285 | 1.8467 | 23.78 | |
| 20 | −74.742 | D(20) | | | |
| 21 | 17.766 | 5.318 | 1.4970 | 81.61 | |
| 22 | −207.519 | 0.150 | | | |
| 23 | 44.145 | 0.800 | 1.9037 | 31.31 | |
| 24 | 12.704 | 10.000 | 1.4970 | 81.61 | |
| 25 | −16.121 | 0.250 | | | |
| 26* | −18.308 | 0.200 | 1.5146 | 49.96 | |
| 27 | −16.129 | 0.800 | 1.8061 | 33.27 | |
| 28 | −28.429 | D(28) | | | |

TABLE 4
(4-1)

| SURFACE NO. | k | A4 | A6 | A8 | A10 | A12 |
|---|---|---|---|---|---|---|
| 1 | 2.5577 | 4.5913E−05 | −1.9316E−07 | 4.5853E−10 | −5.1235E−13 | 2.4987E−16 |
| 2 | −1.0463 | 3.8525E−05 | 2.5374E−07 | −3.5633E−09 | 1.1100E−11 | 1.4916E−15 |
| 17 | −0.4247 | 1.1291E−05 | −1.5611E−08 | 1.0818E−09 | −1.0242E−11 | 0.0000E+00 |
| 26 | 1.0602 | −1.6089E−05 | 2.9999E−08 | 1.0949E−10 | −3.0316E−13 | 0.0000E+00 |

(4-2)

| | WIDE | | TELEPHOTO |
|---|---|---|---|
| | ANGLE END | INTERMEDIATE | END |
| f | 9.299 | 13.997 | 17.756 |
| D(4) | 11.218 | 11.218 | 11.218 |
| D(8) | 11.725 | 4.242 | 1.207 |
| D(16) | 1.147 | 9.401 | 14.726 |
| D(20) | 9.231 | 4.023 | 1.000 |
| D(28) | 38.853 | 46.693 | 53.819 |

### Example 3

### (1) Configuration of Wide-Angle Zoom Lens

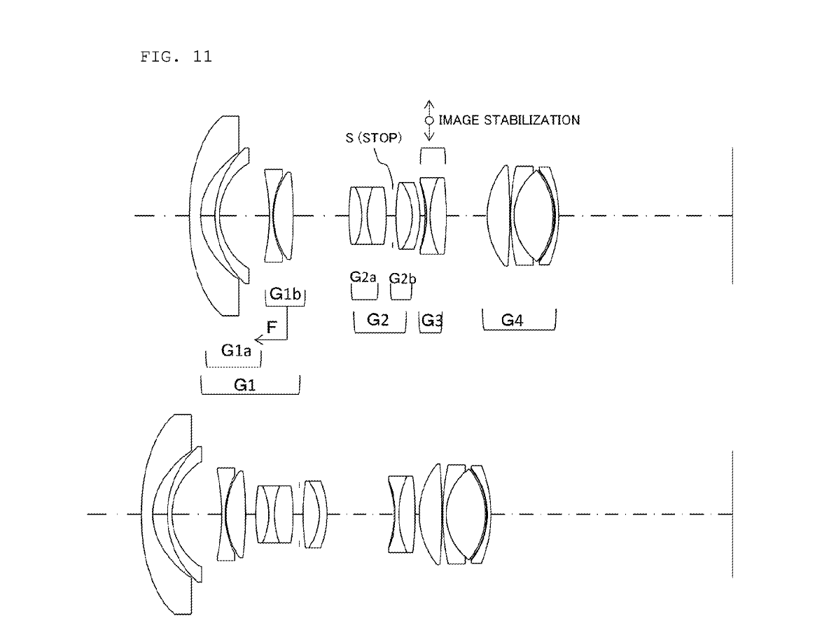

FIG. 11 is a lens cross-sectional view showing a construction of an optical system of a wide-angle zoom lens of Example 3. The wide-angle zoom lens of Example 3 is configured with a first lens group G1 having a negative refractive power, a second lens group G2 having a positive refractive power, a third lens group G3 having a negative refractive power and a fourth lens group G4 having a positive refractive power in that order from the object side.

The first lens group G1 is configured with a front group G1a having a negative refractive power and a rear group G1b having a negative refractive power in that order from the object side. A lens arranged on the most object side in the first lens group G1 is a meniscus lens being concave on the image plane side and having a negative refractive power, and both surfaces of the lens are machined to be aspheric. Further, the rear group G1b is used as a focus group. Focusing from an object at infinity to a short-distance object is performed by moving the rear group G1b to the object side. Specific lens constructions of the front group G1a and the rear group G1b are as shown in FIG. 11.

The second lens group G2 is configured with a front group G2a having a weak positive refractive power and a rear group G2b having a positive refractive power in that order from the object side. An aperture stop S is arranged between the front group G2a and the rear group G2b. The front group G2a, the rear group G2b and the aperture stop S move in an integrated state at the time of magnification change. Specific lens constructions of the front group G2a and the rear group G2b are as shown in FIG. 11.

The third lens group G3 is configured with a cemented lens composed of a negative lens and a positive lens in that order from the object side. The third lens group G3 moves in the direction vertical to the optical axis at the time of image stabilization and used as an image stabilization group for moving an image.

The fourth lens group G4 has a positive refractive power, and its specific lens construction is as shown in FIG. 11.

At the time of zooming (magnification change) from the wide angle end to the telephoto end, each of the lens groups moves to the object side so that the distance between the first lens group G1 and the second lens group G2 is decreased, the distance between the second lens group G2 and the third lens group G3 is increased, and the distance between the third lens group G3 and the fourth lens group G4 is decreased.

### (2) Typical Numerical Values

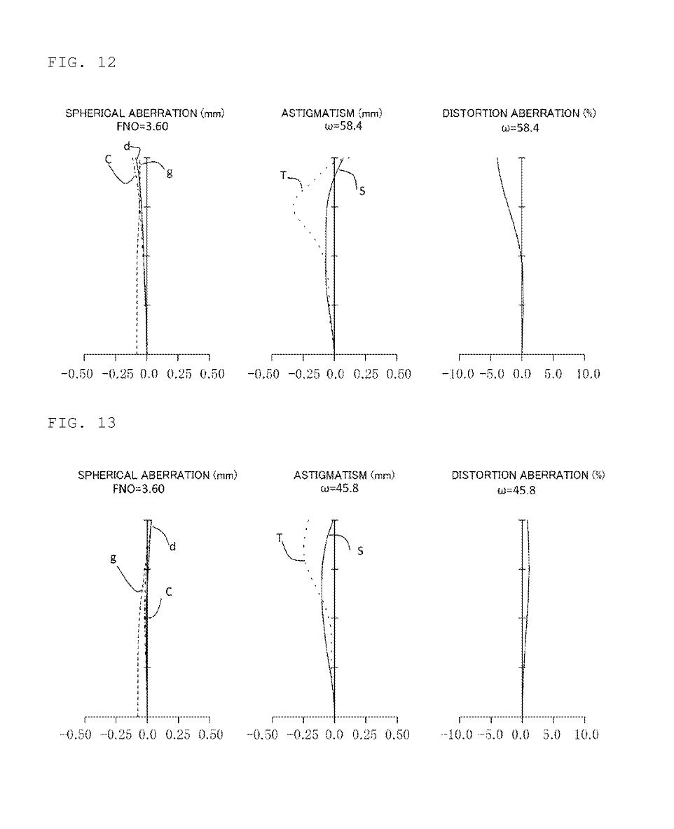

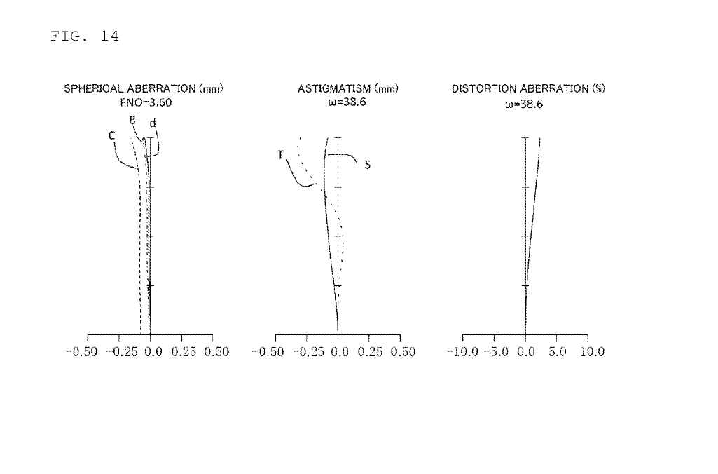

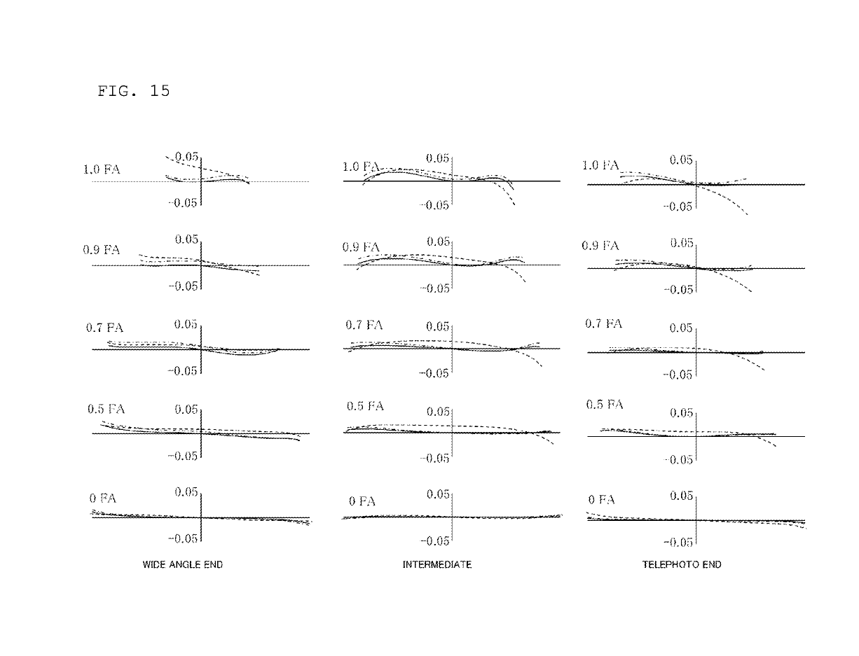

Next, typical numerical values in which specific numerical values of the wide-angle zoom lens are applied will be described. Table 5 shows lens data of the wide-angle zoom lens. Table 6 (6-1) shows an aspheric coefficient and conic constant of each of aspheric surfaces shown in Table 5, and Table 6 (6-2) shows a focal length (f) at each of the wide angle end, the intermediate focal length and the telephoto end of the wide-angle zoom lens, and variable intervals of lens surfaces shown in Table 5 on the optical axis. Further, F values (FNo.) and image viewing angles (2ω) at the wide angle end, the intermediate focal length and the telephoto end of the wide-angle zoom lens will be shown below. Further, numerical values of the expressions (1) to (3) are shown in Table 9. Furthermore, FIGS. 12, 13 and 14 show longitudinal aberration diagrams of the wide-angle zoom lens at the time of infinite-distance focusing at the telephoto end, the intermediate focal length and the wide angle end, respectively, and FIG. 15 shows lateral aberration diagrams at the wide angle end, the intermediate focal length and the telephoto end of the wide-angle zoom lens.

FNO.=3.6 to 4.1 to 4.6

2ω=116.744 to 91.582 to 77.195

TABLE 5

| SURFACE NO. | r | d | Nd | vd | |
|---|---|---|---|---|---|
| 1* | 74.954 | 2.500 | 1.6188 | 63.85 | |
| 2* | 13.514 | 3.262 | | | |
| 3 | 20.065 | 1.000 | 1.8810 | 40.14 | |
| 4 | 13.698 | D(4) | | | |
| 5 | −45.328 | 0.800 | 1.8810 | 40.14 | |
| 6 | 18.745 | 0.143 | | | |
| 7 | 16.550 | 4.413 | 1.6200 | 36.30 | |
| 8 | −79.559 | D(8) | | | |
| 9 | 42.740 | 2.877 | 1.5673 | 42.84 | |
| 10 | −14.848 | 1.237 | 1.8810 | 40.14 | |
| 11 | 17.586 | 4.177 | 1.6477 | 33.84 | |
| 12 | −39.858 | 1.400 | | | |
| 13 | INF | 0.800 | | | (APERTURE |
| | | | | | STOP) |
| 14 | 43.552 | 3.657 | 1.6034 | 38.01 | |
| 15 | −12.797 | 1.740 | 1.9229 | 20.88 | |
| 16 | −19.788 | D(16) | | | |
| 17* | −23.337 | 0.300 | 1.5146 | 49.96 | |
| 18 | −20.426 | 0.800 | 1.8042 | 46.50 | |
| 19 | 20.563 | 3.610 | 1.8467 | 23.78 | |
| 20 | −75.020 | D(20) | | | |
| 21 | 17.633 | 5.073 | 1.4970 | 81.61 | |
| 22 | −138.586 | 0.150 | | | |
| 23 | 49.315 | 0.800 | 1.9037 | 31.31 | |
| 24 | 12.575 | 8.732 | 1.4970 | 81.61 | |
| 25 | −15.855 | 0.250 | | | |
| 26* | −18.304 | 0.200 | 1.5146 | 49.96 | |
| 27 | −16.167 | 0.800 | 1.8061 | 33.27 | |
| 28 | −28.428 | D(28) | | | |

TABLE 6
(6-1)

| SURFACE NO. | k | A4 | A6 | A8 | A10 | A12 |
|---|---|---|---|---|---|---|
| 1 | 2.5577 | 4.5202E−05 | −1.9427E−07 | 4.6432E−10 | −5.1925E−13 | 2.7098E−16 |
| 2 | −1.0425 | 3.8654E−05 | 2.3561E−07 | −3.6475E−09 | 1.1566E−11 | 1.8982E−15 |
| 17 | −0.4032 | 1.1061E−05 | −2.0333E−08 | 1.2532E−09 | −1.2272E−11 | 0.0000E+00 |
| 26 | 1.0146 | −1.8354E−05 | 2.5753E−11 | 3.2010E−10 | −3.5302E−12 | 0.0000E+00 |

(6-2)

| | WIDE | | TELEPHOTO |
|---|---|---|---|
| | ANGLE END | INTERMEDIATE | END |
| f | 9.299 | 13.991 | 17.743 |
| D(4) | 11.127 | 11.127 | 11.127 |
| D(8) | 12.450 | 5.229 | 2.306 |
| D(16) | 1.171 | 9.648 | 14.924 |
| D(20) | 9.125 | 4.006 | 1.000 |
| D(28) | 38.838 | 46.747 | 53.998 |

### Example 4

### (1) Configuration of Wide-Angle Zoom Lens

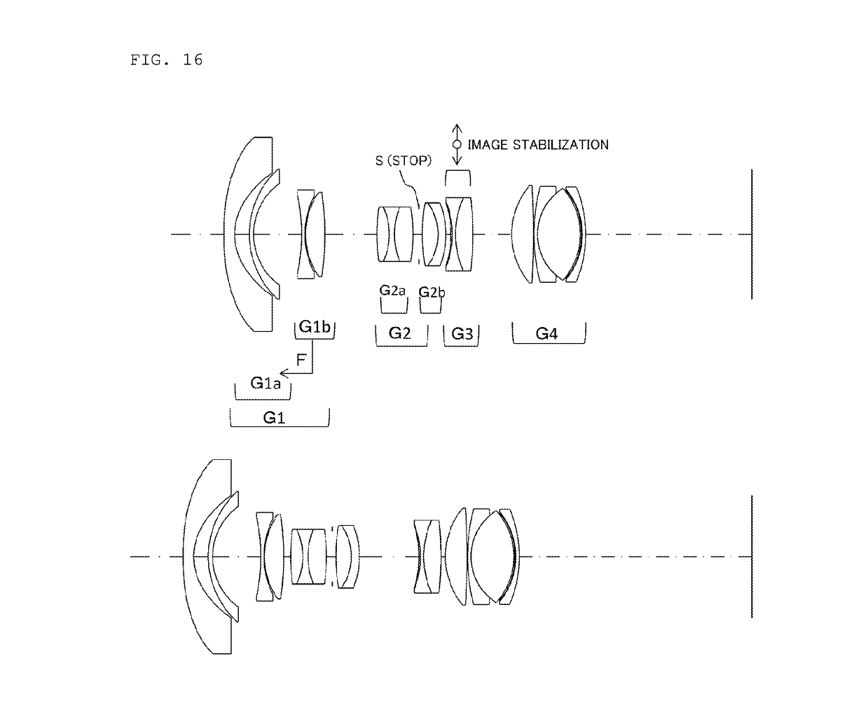

FIG. 16 is a lens cross-sectional view showing a construction of an optical system of a wide-angle zoom lens of Example 4. The wide-angle zoom lens of Example 4 is configured with a first lens group G1 having a negative refractive power, a second lens group G2 having a positive refractive power, a third lens group G3 having a negative refractive power and a fourth lens group G4 having a positive refractive power in that order from the object side.

The first lens group G1 is configured with a front group G1a having a negative refractive power and a rear group G1b having a negative refractive power in that order from the object side. A lens arranged on the most object side in the first lens group G1 is a meniscus lens being concave on the image plane side and having a negative refractive power, and both surfaces of the lens are machined to be aspheric. Further, the rear group G1b is used as a focus group. Focusing from an object at infinity to a short-distance object is performed by moving the rear group G1b to the object side. Specific lens constructions of the front group G1a and the rear group G1b are as shown in FIG. 16.

The second lens group G2 is configured with a front group G2a having a weak positive refractive power and a rear group G2b having a positive refractive power in that order from the object side. An aperture stop S is arranged between the front group G2a and the rear group G2b. The front group G2a, the rear group G2b and the aperture stop S move in an integrated state at the time of magnification change. Specific lens constructions of the front group G2a and the rear group G2b are as shown in FIG. 16.

The third lens group G3 is configured with a cemented lens composed of a negative lens and a positive lens in that order from the object side. The third lens group G3 moves in the direction vertical to the optical axis at the time of image stabilization and used as an image stabilization group for moving an image.

The fourth lens group G4 has a positive refractive power, and its specific lens construction is as shown in FIG. 16.

At the time of zooming (magnification change) from the wide angle end to the telephoto end, each of the lens groups moves to the object side so that the distance between the first lens group G1 and the second lens group G2 is decreased, the distance between the second lens group G2 and the third lens group G3 is increased, and the distance between the third lens group G3 and the fourth lens group G4 is decreased.

### (2) Typical Numerical Values

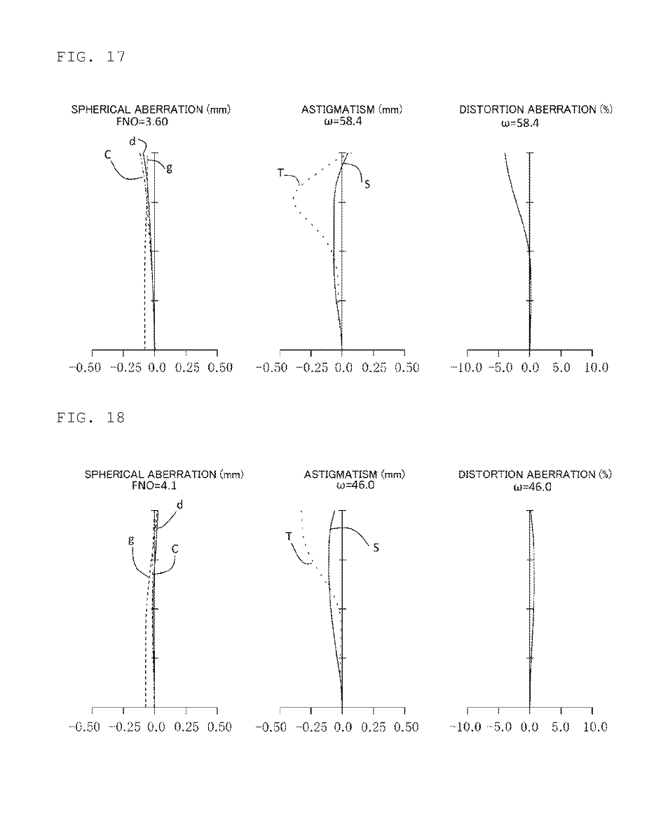

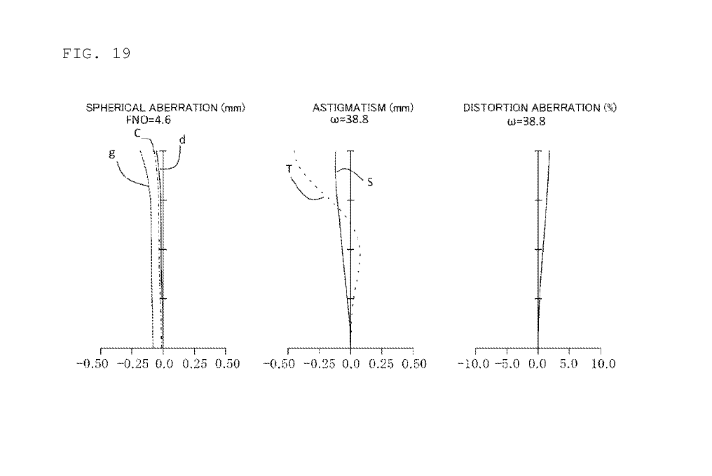

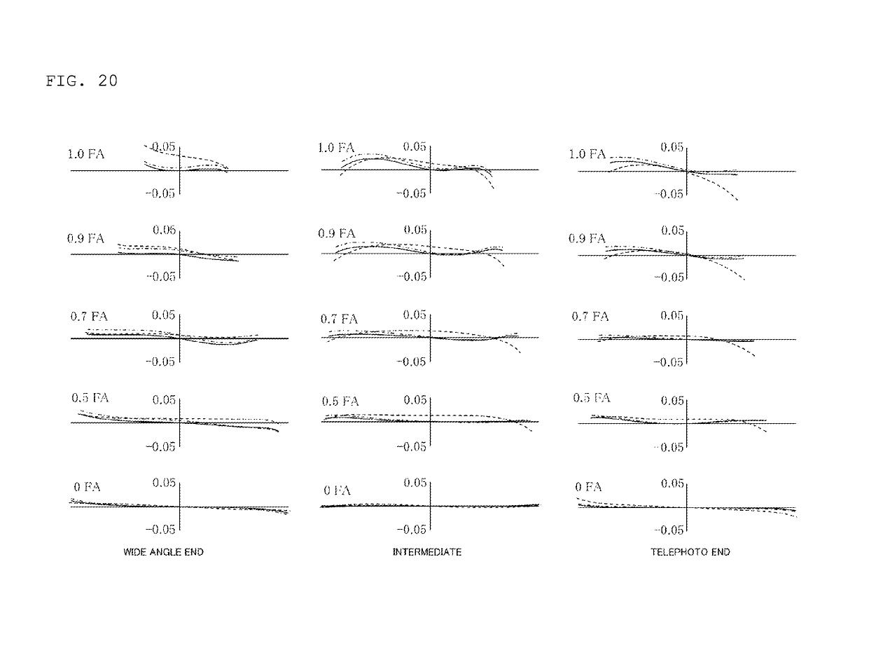

Next, typical numerical values in which specific numerical values of the wide-angle zoom lens are applied will be described. Table 7 shows lens data of the wide-angle zoom lens. Table 8 (8-1) shows an aspheric coefficient and conic constant of each of aspheric surfaces shown in Table 7, and Table 8 (8-2) shows a focal length (f) at each of the wide angle end, the intermediate focal length and the telephoto end of the wide-angle zoom lens, and variable intervals of lens surfaces shown in Table 7 on the optical axis. Further, F values (FNo.) and image viewing angles (2ω) at the wide angle end, the intermediate focal length and the telephoto end of the wide-angle zoom lens will be shown below. Further, numerical values of the expressions (1) to (3) are shown in Table 9. Furthermore, FIGS. 17, 18 and 19 show longitudinal aberration diagrams of the wide-angle zoom lens at the time of infinite-distance focusing at the telephoto end, the intermediate focal length and the wide angle end, respectively, and FIG. 20 shows lateral aberration diagrams at the wide angle end, the intermediate focal length and the telephoto end of the wide-angle zoom lens.

FNO.=3.6 to 4.1 to 4.6

2ω=116.774 to 91.992 to 77.507

TABLE 7

| SURFACE NO. | r | d | Nd | vd | |
|---|---|---|---|---|---|
| 1* | 89.219 | 2.500 | 1.6188 | 63.85 | |
| 2* | 13.620 | 3.423 | | | |
| 3 | 20.350 | 1.000 | 1.8810 | 40.14 | |
| 4 | 14.403 | D(4) | | | |
| 5 | −44.496 | 0.800 | 1.8810 | 40.14 | |
| 6 | 19.593 | 0.122 | | | |
| 7 | 17.111 | 4.483 | 1.6200 | 36.30 | |
| 8 | −70.830 | D(8) | | | |
| 9 | 47.368 | 2.817 | 1.5673 | 42.84 | |
| 10 | −14.949 | 1.237 | 1.8810 | 40.14 | |
| 11 | 16.711 | 4.309 | 1.6477 | 33.84 | |
| 12 | −42.351 | 1.400 | | | |
| 13 | INF | 0.800 | | | (APERTURE |
| | | | | | STOP) |
| 14 | 42.667 | 3.605 | 1.6034 | 38.01 | |
| 15 | −12.599 | 1.887 | 1.9229 | 20.88 | |
| 16 | −19.516 | D(16) | | | |
| 17* | −23.061 | 0.300 | 1.5146 | 49.96 | |
| 18 | −20.138 | 0.800 | 1.8042 | 46.50 | |
| 19 | 20.561 | 4.044 | 1.8467 | 23.78 | |
| 20 | −74.304 | D(20) | | | |
| 21 | 17.525 | 5.076 | 1.4970 | 81.61 | |
| 22 | −199.452 | 0.150 | | | |
| 23 | 44.364 | 0.800 | 1.9037 | 31.31 | |
| 24 | 12.597 | 10.000 | 1.4970 | 81.61 | |
| 25 | −16.007 | 0.250 | | | |
| 26* | −18.390 | 0.200 | 1.5146 | 49.96 | |
| 27 | −16.140 | 0.800 | 1.8061 | 33.27 | |
| 28 | −28.798 | D(28) | | | |

TABLE 8
(8-1)

| SURFACE NO. | k | A4 | A6 | A8 | A10 | A12 |
|---|---|---|---|---|---|---|
| 1 | 2.5577 | 4.5814E−05 | −1.9423E−07 | 4.6270E−10 | −5.1981E−13 | 2.5701E−16 |
| 2 | −1.0462 | 3.8534E−05 | 2.5365E−07 | −3.6339E−09 | 1.1448E−11 | 9.0974E−16 |
| 17 | −0.4262 | 1.1312E−05 | −2.0664E−08 | 1.2417E−09 | −1.2147E−11 | 0.0000E+00 |
| 26 | 1.0288 | −1.8794E−05 | 2.2404E−09 | 2.9154E−10 | −3.0149E−12 | 0.0000E+00 |

(8-2)

| | WIDE | | TELEPHOTO |
|---|---|---|---|
| | ANGLE END | INTERMEDIATE | END |
| f | 9.297 | 13.991 | 17.747 |
| D(4) | 11.252 | 11.252 | 11.252 |
| D(8) | 12.244 | 4.686 | 1.623 |
| D(16) | 1.169 | 8.995 | 13.925 |
| D(20) | 9.073 | 3.942 | 1.000 |
| D(28) | 38.838 | 46.987 | 54.358 |

Table 9 shows numerical values of the expressions (1) to (3) in the “Typical numerical values” and numerical values required to obtain the numerical values of the expressions.

TABLE 9

| | | EXAM- | EXAM- | EXAM- |
|---|---|---|---|---|
| | EXAMPLE 1 | PLE 2 | PLE 3 | PLE 4 |
| EXPRESSION (1) | 0.731 | 1.101 | 1.055 | 1.115 |
| 0.4 < F2/f2b < 2 | | | | |
| EXPRESSION (2) | 0.382 | 0.366 | 0.391 | 0.408 |
| 0.1 < \|F1/F234w\| < 0.7 | | | | |
| EXPRESSION (3) | 3.545 | 3.007 | 3.048 | 3.000 |
| 1 < f2b/Fw < 6 | | | | |
| F1 | −11.974 | −11.258 | −10.750 | −11.238 |
| F2 | 26.708 | 30.777 | 29.895 | 31.102 |
| F2b | 36.518 | 27.964 | 28.344 | 27.887 |
| Fw | 10.300 | 9.300 | 9.299 | 9.297 |
| F234w | 31.312 | 30.796 | 27.495 | 27.559 |

In order to achieve the above object, a wide-angle zoom lens according to one embodiment of the present invention includes: a first lens group having a negative refractive power, a second lens group having a positive refractive power, a third lens group having a negative refractive power and a fourth lens group having a positive refractive power in that order from an object, wherein the second lens group is configured with a front group, a stop and a rear group having a positive refractive power in that order from the object side; and magnification change is performed by changing distances among the lens groups.

It is preferable that, in the optical system according to one embodiment of the present invention, an expression (1) below is satisfied.

0.4<F2/f2b<2 (1)

wherein

F2 represents focal length of the second lens group; and

f2b represents focal length of the rear group of the second lens group.

In the wide-angle zoom lens according to one embodiment of the present invention, it is preferable to, at the time of image stabilization, move an image by moving the third lens group in a direction vertical to an optical axis.

It is preferable that, in the wide-angle zoom lens according to one embodiment of the present invention, an expression (2) below is satisfied.

0.1<|F1/F234w|<0.7 (2)

wherein

F234w represents focal length of all lens groups arranged on an image plane side of the first lens group at a wide angle end; and

F1 represents focal length of the first lens group.

In the wide-angle zoom lens according to one embodiment of the present invention, it is preferable that the first lens group is configured with a front group having a negative refractive power and a rear group having a negative refractive power in that order from the object, that focusing from an object at infinity to a short-distance object is performed by moving the rear group to the object side, and that an expression (3) below is satisfied.

1<f2b/Fw<6 (3)

wherein

FW represents focal length of an entire wide-angle zoom lens system at the wide angle end; and

f2b represents focal length of the rear group of the second lens group.

In the wide-angle zoom lens according to one embodiment of the present invention, each of the front and rear groups of the second lens group is configured with at least one negative lens and one positive lens.

An image pickup apparatus according to one embodiment of the present invention includes the wide-angle zoom lens described above and an image sensor receiving an image formed by the wide-angle zoom lens.

According to one embodiment of the present invention, it is possible to provide a wide-angle zoom lens which has almost the same zoom ratio as a conventional one and in which a wider image viewing angle at a wide angle end is achieved, and a first lens group can be configured small so that the overall optical length is short.

According to the present invention, it is possible to provide a wide-angle zoom lens which has almost the same zoom ratio as a conventional one and in which a wider image viewing angle at a wide angle end is achieved, and a first lens group can be configured small so that the overall optical length is short.

### REFERENCE SIGNS LIST

G1 first lens group
G1a front group
G1b rear group
G2 second lens group
G2a front group
G2b rear group
G3 third lens group
G4 fourth lens group
S aperture stop

What is claimed is:

1. A wide-angle zoom lens comprising:
a first lens group having a negative refractive power, a second lens group having a positive refractive power, a third lens group having a negative refractive power and a fourth lens group having a positive refractive power in that order from an object side, wherein
the second lens group is configured with a front group, a stop and a rear group having a positive refractive power in that order from the object side; and
magnification change is performed by changing distances among the lens groups.

2. The wide-angle zoom lens according to claim 1, satisfying an expression (1) below:
0.4<F2/f2b<2 (1)
wherein
F2 represents focal length of the second lens group; and
f2b represents focal length of the rear group of the second lens group.

3. The wide-angle zoom lens according to claim 1, wherein, at the time of image stabilization, an image is moved by moving the third lens group in a direction vertical to an optical axis.

4. The wide-angle zoom lens according to claim 1, satisfying an expression (2) below:
0.1<|F1/F234w|<0.7 (2)
wherein
F234w represents focal length of all lens groups arranged on an image plane side of the first lens group at a wide angle end; and
F1 represents focal length of the first lens group.

5. The wide-angle zoom lens according to claim 1, wherein
the first lens group is configured with a front group having a negative refractive power and a rear group having a negative refractive power in that order from the object side;
focusing from an object at infinity to a short-distance object is performed by moving the rear group of the first lens group to the object side; and
an expression (3) below is satisfied:
1<f2b/Fw<6 (3)
wherein
FW represents focal length of an entire wide-angle zoom lens system at a wide angle end; and
f2b represents focal length of the rear group of the second lens group.

6. The wide-angle zoom lens according to claim 1, wherein each of the front and rear groups of the second lens group is configured with at least one negative lens and one positive lens.

7. An image pickup apparatus comprising:
the wide-angle zoom lens according to claim 1; and
an image sensor receiving an image formed by the wide-angle zoom lens.
